(19) United States
(12) Patent Application Publication
(10) Pub. No.: US 2004/0119300 A1
(43) Pub. Date: Jun. 24, 2004

(54) Welded-in striker backing plate

(75) Inventors: Steven C. Strable, Rochester, MI (US); Raymond N. Kreucher JR., St. Hts, MI (US); Robert C. Reid, Rochester Hills, MI (US); Michael R. Smart, Waterford, MI (US); Derek F. Bigenho, Chesterfield, MI (US); Larry M. Storinsky, Rochester Hills, MI (US); Jack R. Tappainer, Machesney Park, IL (US)

Correspondence Address: Ralph E. Smith, DaimlerChrysler Intellectual Capital Corporation, 800 Chrysler Drive East, Auburn Hills, MI, 48326-2757, US

(73) Assignee: DaimlerChrysler Corporation

(21) Appl. No.: 10/321,576

(22) Filed: Dec. 18, 2002

(51) Int. Cl. E05B 15/02

(52) U.S. Cl. 292/341.18

(57) ABSTRACT

A bracket is adapted for connection to a vehicle body part in order to mount a striker cooperating with a door lock mechanism of a motor vehicle. The striker is to be rigidly secured by bolts to the vehicle body part. The bracket includes a striker mount portion, with holes defined therein adapted to receive the bolts, and a weld portion, by which the bracket can be welded to the back surface of the vehicle body part. A pair of deformable limbs interconnects the striker mount portion and the weld portion. By way of these deformable limbs, a position of the striker mount portion relative to the weld portion is adjustable to change the positions of the holes and accommodate repositioning of the bolts. The limbs have offset portions which are laterally displaced with respect to the striker mount portion and the weld portion such that the offset portions include side surfaces parallel to but not co-planar with side surfaces of the striker mount and weld portions. A process for adjusting the position at which a striker is mountable is also contemplated.

### BACKGROUND OF THE INVENTION

1. Field of the Invention

This invention generally concerns a structure by which a striker cooperating with a motor vehicle door lock can be adjustably mounted in position on the vehicle.

2. Description of Related Art

U.S. Pat. No. 4,323,271 to Taniguchi discloses a structure for mounting a striker which cooperates and engages with a vehicle door lock mechanism. A plate member having at least one deformable portion is welded in position to a vehicle body so that bolt-receiving apertures in the plate member and nuts welded to the plate member are properly located. If it is necessary to adjust the position of the striker before the striker is rigidly secured to the vehicle body, the at least one deformable portion permits horizontal and/or vertical adjustment.

### SUMMARY OF THE INVENTION

Objects of this invention include providing a one-piece plate structure which can replace a conventional two-piece basket and cage striker mounting design, providing improved multi-directional adjustability, and facilitating automated assembly. According to the invention, a bracket, to which a striker cooperating with a door lock mechanism of a motor vehicle is mountable, is adapted for connection to a back surface of a vehicle body part. The striker is to be rigidly secured in place by bolts. The bracket includes a striker mount portion, with holes defined therein adapted to receive the bolts, and a weld portion, by which the bracket can be welded to the back surface of the vehicle body part. A pair of deformable limbs interconnects the striker mount portion and the weld portion. By way of these deformable limbs, a position of the striker mount portion relative to the weld portion is adjustable to change the positions of the holes and accommodate repositioning of the bolts. The limbs include offset portions which are laterally displaced with respect to the striker mount portion and the weld portion such that the offset portions include side surfaces parallel to but not co-planar with side surfaces of the striker mount and weld portions. The offset portions of the limbs allow the striker mounting attachment holes to adjust linearly with respect to the shut face mating clearance holes such that the holes do not rotate around the welded portion. A process for adjusting the position at which a striker is mountable is also contemplated. A process for adjusting a plate “trend set” includes welding the plate in a dimensionally positioned location. As the installation of the striker occurs, limbs of the plate allow for repositioning of the two-hole system to accommodate closure fit build variation.

### BRIEF DESCRIPTION OF THE DRAWINGS

FIG. 1 is a plan view of a bracket or tapping plate according to the invention;

FIG. 2 is a side view of the bracket or tapping plate shown in FIG. 1;

FIG. 3 is an end view of the bracket or tapping plate shown in FIG. 1;

FIGS. 4-8 show alternative bracket or tapping plate embodiments according to the invention;

FIGS. 9-10 show brackets or tapping plates according to FIG. 1 mounted to vehicle parts;

Figure 11 is a view, partly in section, of a door striker having a base portion with mounting holes aligned with both clearance holes in a vehicle body and internally threaded bores in nuts of the bracket or tapping plate; and

FIG. 12 is a view showing the bracket or tapping plate attached to a vehicle center pillar or quarter panel and illustrating directions in which positional adjustment of the plate can occur.

### DETAILED DESCRIPTION OF THE INVENTION

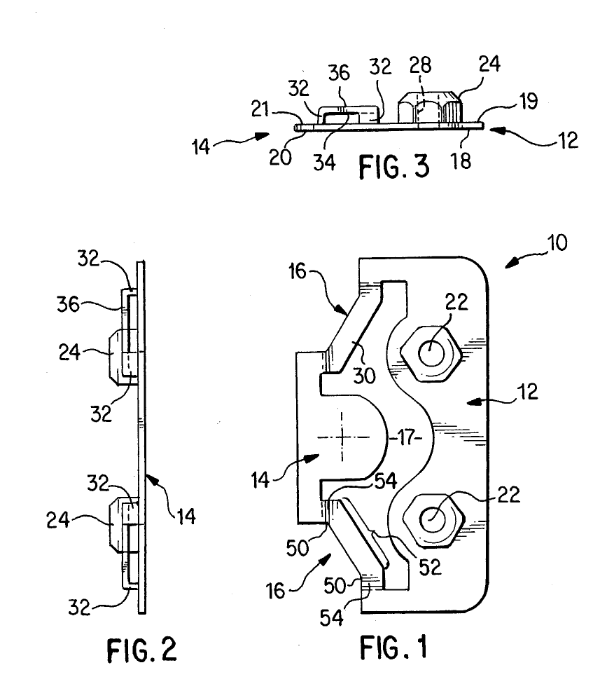

The bracket or tapping plate 10 of FIGS. 1-3 includes a striker mount portion 12, a weld portion 14, and limbs 16 disposed between and interconnecting the striker mount portion 12 and the weld portion 14. As seen in the plan view of FIG. 1, the striker mount portion, the weld portion and the limbs circumscribe an irregular central hole 17 in the bracket or tapping plate. The striker mount portion 12 has a first flat side surface 18 which is substantially co-planar with a first flat side surface 20 of the weld portion 14, and a second flat side surface 19 which is substantially co-planar with a second flat side surface 21 of the weld portion 14. A pair of holes 22 is defined in the striker mount portion 12. Nuts 24 are secured to the striker mount portion second side surface 19 by welding, soldering, adhesive bonding, or in some other suitable fashion. It is conceivable to integrally form the nuts 24 together with the rest of the bracket 10 by casting, for example. Each of the nuts 24 includes an internally threaded bore 28 aligned with one of the striker mount portion holes 22.

Each of the limbs 16 shown in FIGS. 1-3 includes a narrow elongated leg 30, having fist and second flat side surfaces 34 and 36, and a depending end flange 32 at each end of the leg. The depending end flanges 32 at the ends of each elongated leg 30 interconnect that leg with the remainder of the bracket or tapping plate. By way of the depending end flanges 32, each of the legs 30 is offset and laterally displaced relative to the striker mount portion 12 and the weld portion 14. As a result of this lateral displacement, the first side surface 34 of each leg 30 is roughly parallel to but not co-planar with the first side surfaces 18 and 20, and the second side surface 36 of each leg is roughly parallel to but not co-planar with the second side surfaces 19 and 21.

The narrow elongated configuration of the leg 30 of each limb 16 provides for easy deformation and facilitates adjustment in the position of the striker mount portion 12 relative to the weld portion 14. The lateral displacement of the legs 30 relative to the remainder of the bracket or tapping plate avoids any interference between the striker mount portion, the weld portion and the legs during positional adjustment of the striker mount portion 12.

The laterally displaced elongated legs 30 may be provided with any of a variety of configurations. As shown in FIG. 3, the first embodiment of the invention includes legs 30 having a pair of elbows or beads 50 interconnecting three linear leg sections, namely a linear central leg section 52 and short linear leg sections 54 at each end of the central leg section

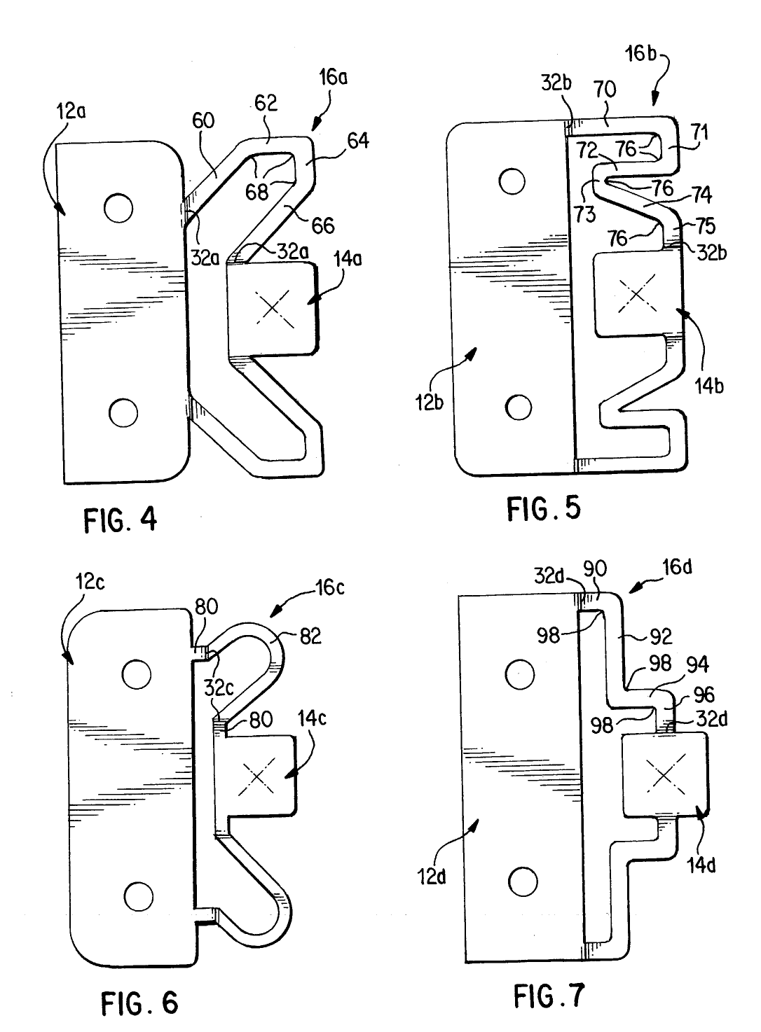

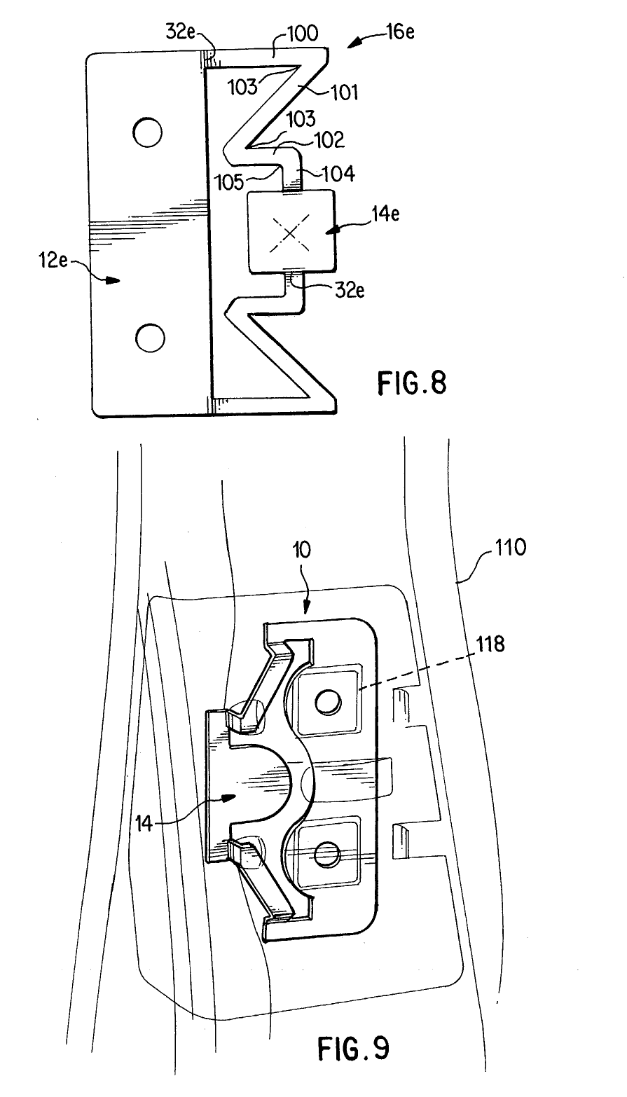

FIGS. 4-8 illustrate alternative bracket or tapping plate embodiments. FIG. 4 shows a striker mount portion 12a and a weld portion 14a interconnected by deformable limbs 16a of modified configuration. Each limb 16a of FIG. 4 is of a recurved configuration and is formed by a leg having four linear leg sections 60, 62, 64, and 66, depending end flanges 32a, and suitable elbows or bends 68 interconnecting the leg sections. FIG. 5 shows a striker mount portion 12b and a weld portion 14b interconnected by deformable limbs 16b. Each limb 16b, as illustrated, is formed by a leg having six linear leg sections 70-75, depending end flanges 32b, and suitable elbows or bends 76 interconnecting the leg sections. FIG. 6 shows a striker mount portion 12c and a weld portion 14c interconnected by deformable limbs 16c. Each limb 16c is formed by a leg having short linear leg sections 80, a recurved leg section 82, and depending end flanges 32c. FIG. 7 shows a striker mount portion 12d and a weld portion 14d interconnected by deformable limbs 16d. Each limb 16d is formed by a leg having four linear leg sections 90, 92, 94, and 96, depending end flanges 32d, and suitable right-angle elbows or bends 98 interconnecting adjacent linear leg sections. FIG. 8 shows yet another configuration having a striker mount portion 12e and a weld portion 14e interconnected by deformable limbs 16e. Each limb 16e includes a leg with three linear leg sections 100, 101, and 102 interconnected by acute angle elbows or bends 103, a fourth leg section 104 interconnected to one of the other three legs by a right-angle elbow or bend 105, and depending end flanges 32e. Combinations of the various limb configurations described are also possible.

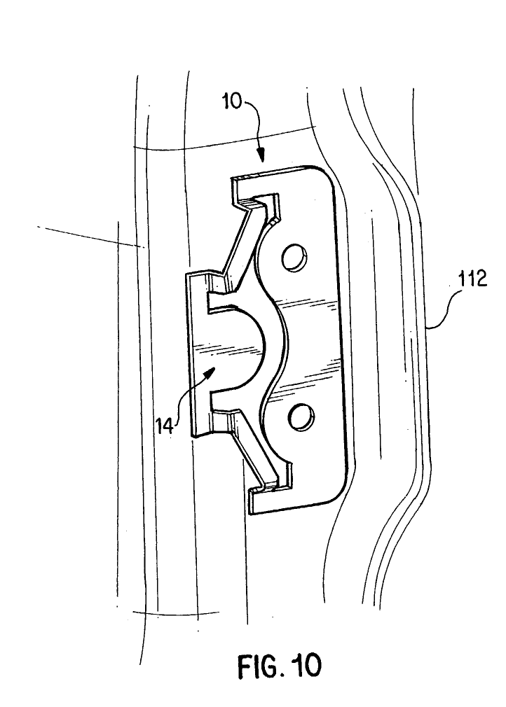

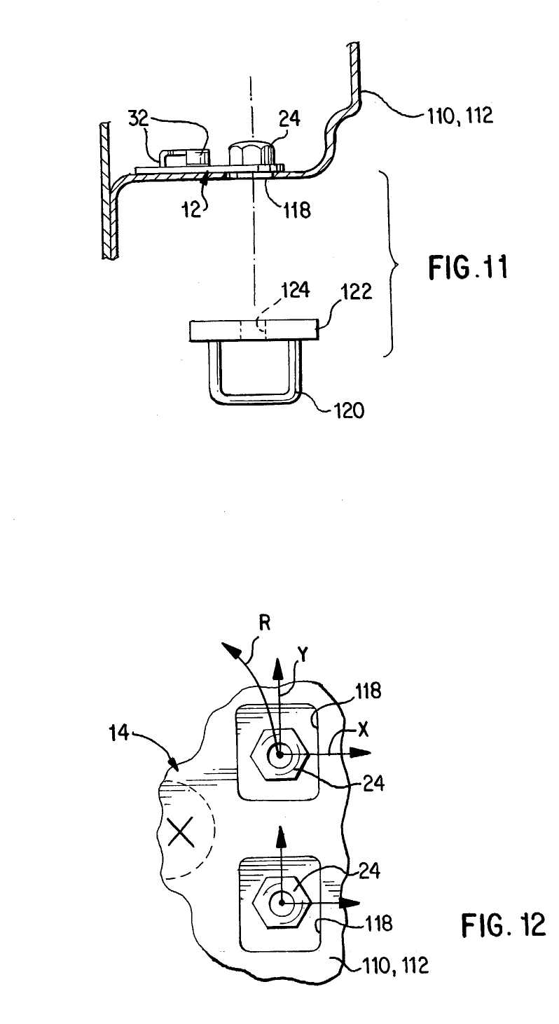

FIGS. 9 and 10 illustrate bracket or tapping plates 10 such as that shown in FIGS. 1-3 as mounted to a vehicle center pillar 110 (FIG. 9) and quarter panel 112 (FIG. 10). For clarity, in each of FIGS. 9 and 10, only the bracket plate 10 is shown; illustrations of nuts 24 are not provided. As with the striker mounting structure of the Taniguchi patent, in order to mount the bracket or tapping plate 10 of the present invention, the bracket or tapping plate is arranged so that the positions of the internally threaded bores of the nuts and the striker mount portion holes 22 are aligned with bolt insert apertures or clearance holes 118 of the vehicle body as shown in FIG. 11. The weld portion 14 of the bracket or tapping plate is then welded to the back surface of the striker mount portion of the vehicle body. A striker 120 can be rigidly secured to the vehicle body by inserting bolts (not shown) through apertures 124 in a base portion 122 of the striker from outside of the vehicle body and engaging the bolts with the internally threaded bores 28 of the nuts 24.

By deforming the limbs 16-16e of the bracket or tapping plate, the position of the striker mount portion 12 relative to the weld portion 14 can be changed. Consequently, even though the bracket or tapping plate 10 is welded into a nominal build condition, the locations of the bracket holes 22 can be manually tapped to a new bolt location trend until the bracket location can be fixture adjusted to a revised nominal position in the event a build variation occurs. This design enables the plant to maintain a short-term automated weld-in build. Welding the structure in replaces a more expensive basket and cage assembly. The offset features of the bracket or tapping plate enable adjustment of the bracket or tapping plate in the plant to mirror trend set builds. The depending end flanges 32 allow the striker mount portion 12 to be adjusted uniformly and linearly in directions X and Y, represented in FIG. 12, independently of a rotational tendency in direction R about the weld.

The bracket or tapping plate 10 enables the plate to be positioned during assembly such that striker-positioning fixtures on the trim side of the plant are unnecessary. The plate positioning function can be done during body shop fixturing and trend set to build conditions. The offset features enable adjustment of the tapping plate if needed prior to making a trend move in the fixtures. The offset locations are located to provide uniform re-adjustment of the holes to the build condition. The readily adjustable hole spacing and positioning relative to, or square to, the body provide for proper fit of the striker for proper door latch function.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A bracket to which a striker cooperating with a door lock mechanism of a motor vehicle is mountable and which is adapted for connection to a back surface of a vehicle body part to which the striker is to be rigidly secured by bolts comprising:
a striker mount portion including holes defined therein which are adapted to receive the bolts,
a weld portion by which the bracket can be welded to the back surface of the vehicle body part, and
a pair of deformable limbs interconnecting the striker mount portion and the weld portion by which a position of the striker mount portion relative to the weld portion is adjustable to change the positions of the holes and accommodate repositioning of the bolts,
wherein the limbs include offset portions which are laterally displaced with respect to the striker mount portion and the weld portion such that the offset portions include side surfaces which are not co-planar with side surfaces of the striker mount and weld portions.

2. The bracket according to claim 1, wherein each of the deformable limbs is formed by a elongated leg and depending flanges at each end of the leg interconnecting the leg to the striker mount and weld portions.

3. The bracket according to claim 2, wherein the elongated leg includes bends interconnecting three linear leg sections.

4. The bracket according to claim 2, wherein the elongated leg includes a portion which is recurved.

5. The bracket according to claim 2, wherein the elongated leg includes four linear leg sections interconnected by bends.

6. The bracket according to claim 2, wherein the elongated leg includes six linear leg sections interconnected by bends.

7. The bracket according to claim 5, wherein the bends are right-angle bends.

8. The bracket according to claim 5, wherein the linear leg sections include three linear leg sections interconnected by acute angle bends and another linear leg section interconnected to one of said three linear leg sections by a right-angle bend.

9. The bracket according to claim 1, and further comprising nuts secured to one of the side surfaces of the striker mount portion having threaded bores adapted to receive the bolts.

10. The bracket according to claim 1, wherein the side surfaces of the offset portions are parallel to the side surfaces of the striker mount and weld portions.

11. A process for adjusting a position at which a striker cooperating with a door lock mechanism of a motor vehicle is mountable to a back surface of a vehicle body part to which the striker is to be rigidly secured by bolts comprising:
providing a bracket having a striker mount portion including holes defined therein which are adapted to receive the bolts, a weld portion by which the bracket can be welded to the back surface of the vehicle body part, and a pair of deformable limbs interconnecting the striker mount portion and the weld portion, the limbs including offset portions which are laterally displaced with respect to the striker mount portion and the weld portion such that the offset portions include side surfaces which are not co-planar with side surfaces of the striker mount and weld portions, and
adjusting a position of the striker mount portion relative to the weld portion to change the positions of the holes and accommodate repositioning of the bolts.

12. The process according to claim 11, wherein adjusting the position of the striker mount portion is performed by tapping the striker mount portion.
